(19) United States
(12) Patent Application Publication
(10) Pub. No.: US 2009/0289128 A1
(43) Pub. Date: Nov. 26, 2009

(54) Enhancement of fragrance release from top of candles continuity

(76) Inventors: Ben Warren Borchert, Syracuse, UT (US); Bart Kennington, Layton, UT (US); Brian Beesley, Draper, UT (US)

Correspondence Address: Lynn G. Foster, 65 N Street, Suite C3, Salt Lake City, UT, 84103, US

(21) Appl. No.: 12/319,198

(22) Filed: Jan. 2, 2009

Related U.S. Application Data
(63) Continuation-in-part of application No. 12/125,034, filed on May 21, 2008.

(51) Int. Cl. B05B 1/24; B05B 7/32

(52) U.S. Cl. 239/136; 239/337

(57) ABSTRACT

Combinations, assemblies and methods for releasing candles and like objects to promptly flamelessly release a fragrance are disclosed, which utilize a heater and a fan disposed above or at the top of the candle whereby heat and forced air are applied to the top of the material in the container.

This Application is a continuation-in-part of U.S. patent application Ser. No. 12/125,034, filed May 9, 2005.

### FIELD OF INVENTION

The present invention relates generally to emission of fragrance from a candle or the like and, more particularly, to novel combinations, assemblies and methods by which a normally solid candle or like item in a receptacle or container is melted by heat applied from above the candle using a flameless heating element and, in some embodiments a directional fan is used.

### BACKGROUND

Perfumed candles and like fragrance-releasing materials in a solid state at room temperature are typically placed in a container, such as an open top glass vessel. Fragrance is typically emitted from the material comprising the candle or like item by either burning an exposed wick which melts the top of the candle, or externally heating the bottom of the container with an external source of heat to flamelessly melt to lower portions of the candle or like object.

Wick burning releases pollutants, which to some extent mutes the perfume fragrance also being released, and, with some candle compositions, can be harmful to health while creating a fires hazard.

Non-uniform heating of the material from the bottom can result in an explosion, risking human injury and destroying the assembly including the container. Since heating from the bottom must change the phase of the material at the top from solid to liquid before gaseous fragrance is flamelessly released, the non-fragrance time delay between applying bottom heat and obtaining the fragrance creates impatience with many consumers.

### BRIEF SUMMARY AND OBJECTS OF THE INVENTION

In brief summary, the present invention overcomes or alleviates problems pertaining to the release of fragrance from and/or the melting of candles and the like. Flameless heat is applied from above to the material from which the containerized candle or like item is made, whereby melting at the top of the material occurs promptly, resulting in a much faster flameless release of fragrance from the material. A one-way and two-way fan accelerates heating and efficacious release of aroma.

With the foregoing in mind, it is a primary object to overcome or alleviate problems of the past pertaining to release of fragrance from and/or the melting of candles and like items.

Another valuable object is the provision of novel combinations or assemblies and unique methods for accelerated release of fragrance from and/or melting candles and like items by applying flameless heat to the top of the candles and like items, and using fan displacement of air onto and away from the top of the candle.

A further paramount object is the provision of novel combinations, assemblies and method utilizing an elevated flameless heat source and displacement of air to promptly melt the top of a containerized candle or like item thereby rapidly flamelessly releasing fragrance.

A further significant object is to utilize fan-displaced air and flameless heat to accelerate melting at the top of a containerized candle and to more rapidly and more effectively release fragrance from the top of the candle.

These and other objects and features of the present invention will be apparent from the detailed description taken with reference to accompanying drawings.

### BRIEF SUMMARY AND OBJECTS OF THE INVENTION

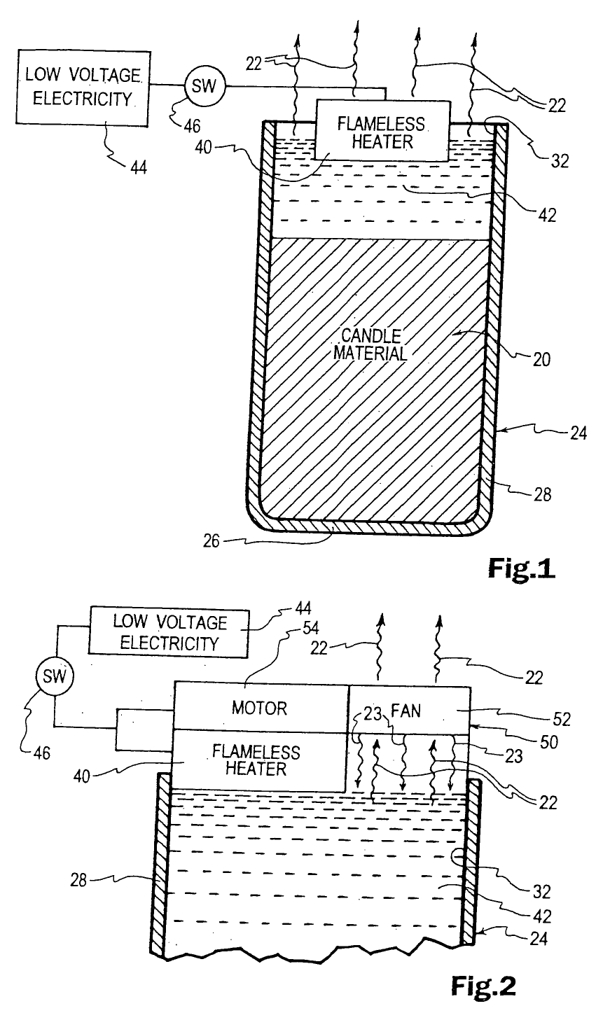

FIG. 1 is a schematic of a system for quickly melting the top of a candle or like item to provoke promptly release of fragrance;

FIG. 2 is a schematic of another system according to the present invention similar to FIG. 1 but comprising a heat and fragrance displacing fan;

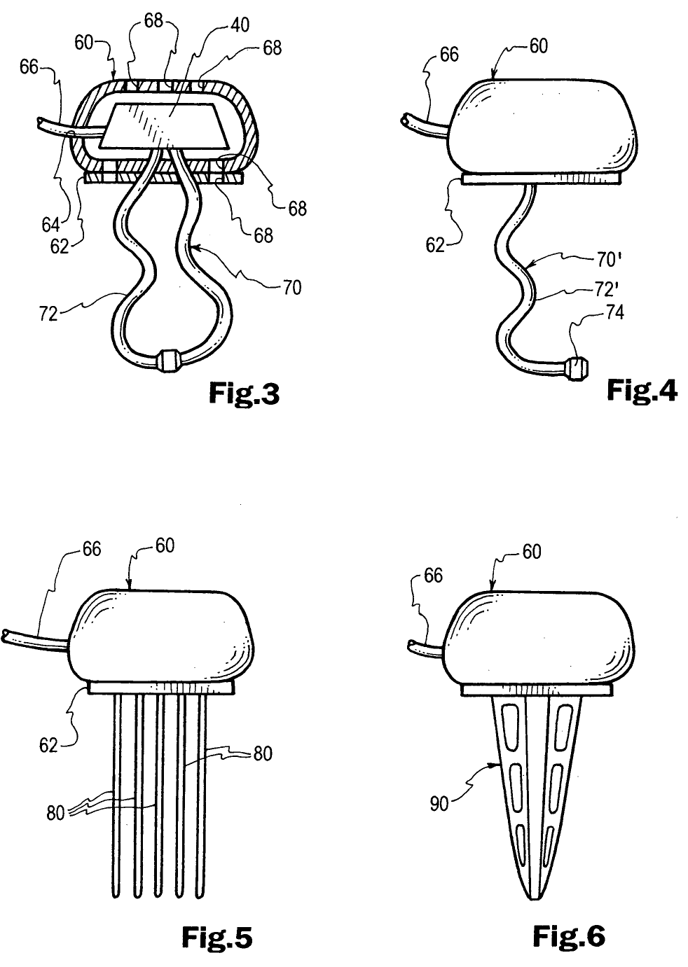

FIGS. 3 through 6 are elevations (with parts broken away in FIG. 3) depicting various types of heating elements for melting the candle material from the top down; and

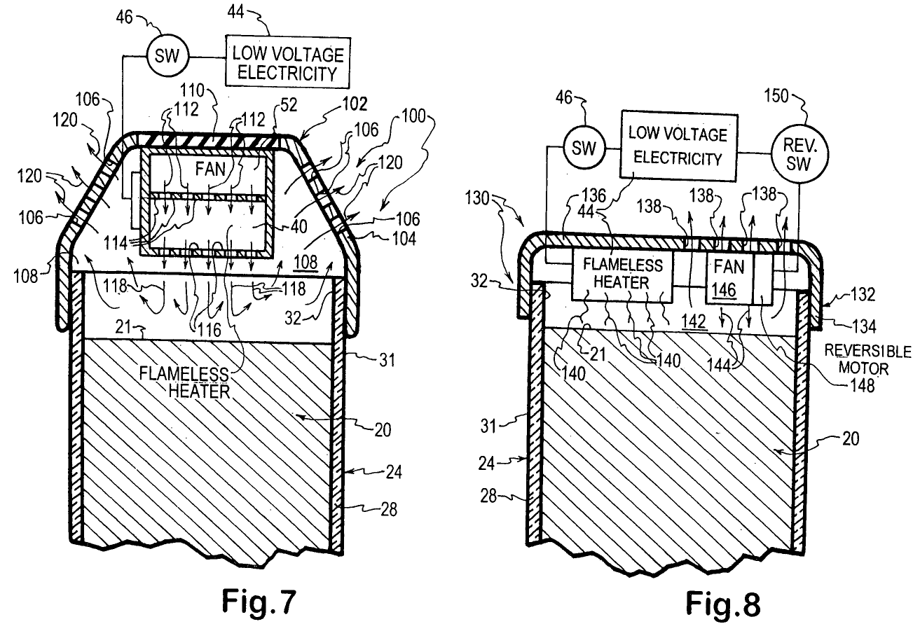

FIGS. 7 through 12 are schematics of systems of the present invention comprising fans to displacing air onto and aroma away from the candle top.

### DETAILED DESCRIPTION OF THE ILLUSTRATED EMBODIMENTS

References is now made to the drawing wherein like numerals are used to designate like parts throughout. The present invention relates generally to accelerated emission of fragrance from a material used to form candles or like objects and comprises combinations, assemblies and methods by which a top region of a normally solid candle or like object in a receptacle, vessel or container is melted, without combustion, by heat applied from above directly to or against the material comprising the candle. While the elevated source of heat may be spaced from the top of the candle-forming material, in the alternative, a heating element may be on or embedded in the material which promptly melts the top of the material. A one-way or a two-way fan displaces air above ambient temperature onto the top of the material and fragrance into the surrounding environment.

Typically, the vessel is formed as one piece and comprised of glass so that the material from which the candle is made is visually observable through the vessel. Fragrance emission is due to top melting. Because candle burning producing emissions of combustion, ordinarily in confined locations, such as homes, it is preferred that top melting alone, without combustion, be the mode by which fragrance 22 (FIG. 1) is emitted. In this way, the fragrance is promptly made available without potentially harmful releases of pollutants due to combustion, also eliminating the risk of fire caused by a burning candle.

Any source of low voltage flameless heat may be utilized to first melt the top region of the candle or like object in the vessel. When the fragrance is no longer desired, the user simply shuts the elevated heater off, allowing the material from which the candle or like object is formed to return from a liquid state to a solid state. While the fragrance emission technique of the present invention may utilize a candle with a wick because of ready commercial availability, there is no absolute requirement that the object to be melted be a candle per se nor that the wick be part of the object melted.

There is no constraint on the type of fragrance to be emitted, nor on the shape of the vessel, candle or heat-conductive core element embedded in the material of which the candle or like object is comprised. The present invention embraces any suitable way of heating and melting the top region of the aroma-emitting material within the vessel.

Fan displacement of air of above ambient temperature onto the top of the candle material accelerates melting and fan displacement of fragrance away from the candle top both have significant value.

Attention is directed to FIG. 1, which schematically illustrates a pre-existing solid quantity of candle material, generally designated 20, encased by or confined in a vessel or container, generally designated 24. The vessel 24 is illustrated as being formed as one piece so as to comprise a bottom wall 26, a hollow cylindrical side wall 28, and an opening 32 through which fragrance from the perfumed material 20 escapes from the vessel 24 upon the application of heat to the top region of the material 20. Low voltage electricity 44, which may be a battery or transformed from 110 volt household electricity, is communicated to the heater 40 across an on-off switch 46 when in the on position.

Heretofore, the process of melting the material 20 has been slow and non-uniform, because heat was applied through the bottom 26 of the vessel 24 to the material 20. To address this problem, the present invention utilizes a heat source, generally designated 40, which promptly melts or liquefies the top region 42 of the material 20. Any suitable heater 40 may be used. The heater 40, with switch 46 on, may emit heat directly onto the top region 42 of the material 20 so as to not require physical contact between a heating element and the top region 42 of the material 20, which lowers over time due to consumption of the material 20. The heater 40, in the alternative, may comprise a heating element which is and remains contiguous with the top region 42. A fan may be used to drive above ambient temperature air against the candle top and/or fragrance-containing air into the surrounding environment.

As shown in FIG. 2, the heater 40 may be disposed in a pervious lid 50, releasibly press fit into the top opening 32 of the vessel 24. Lid 50 is also shown as containing a two-way fan 52, driven by a motor 54, which accommodates displacement of air at an elevated temperature onto the top of the candle and displacement of the released aroma or fragrance 22 carried by error through the pervious lid 52 to the surrounding ambient environment. Fan 52 may be a two-direction fan driven by a reversible motor 54 to both displace fragrance away from the candle top to drive above ambient air onto the candle top to accelerate melting of the candle material.

FIG. 3 illustrate a pervious lid 60, to be releasibly press-fit into opening 32 of the container 24 at a base 62. The lid 60 comprises an aperture 64 in one side of the lid 60 through which a conductor 66 communicates low voltage electricity to heater 40, encased in the lid 60. Apertures 68 in the lid 60 and base 62 accommodate flow of fragrance to the surrounding ambient environment. The heater 40 comprises a heating element, generally designated 70, in the form of an endless loop melting cable 72, which rests, prior to activation, on the solid top surface of the material 20, and, upon activation melts the top region 42 and lowers, due to gravity, into the melted material.

FIG. 4 illustrates use, in conjunction with lid 60, of second form heating element, generally designated 70′, in the form of a length of melting cable 72′ having a distal end 74. Melting cable 72′ functions to first rest upon and, when energized, to melt the top region of the material in the vessel 24, sinking into the material, due to gravity, as the material melts.

As shown in FIG. 5, in lieu of either melting cable 72 or 72′, a plurality of heating element probes 80 may be used. Probes 80 are initially forced into the solid material 20 in the vessel 24 as the base 62 of the lid 60 is inserted into the top opening 32 of the vessel. The inserted probes 80, when electrically energized, will melt the material 20 from the top down. The length of the probes takes into account that the material 20 is consumable. Therefore, the top surface of the material 20 lowers over time.

As shown in FIG. 6, in lieu of rod-like probes 80, other forms of heating probes, such as pointed piercing-heating element 90, may be used in conjunction with heather 40 and lid 60 to heat from the top down. Heating element 90 functions essentially the same as probes 80.

FIG. 7 illustrates, in enlarged fragmentary cross section and schematically, a further embodiment of the present invention, generally designated 100. A porous lid, generally designated 102 is removably press fit around the exterior surface 31 at the top of the container or vessel 24, candle material 20, containing fragrance, being disposed within the vessel or container 28. The cap or lid 102 can be manually lifted away from the vessel 28, when desired. The lid 102 is crown shaped, comprising a dome-shaped layer 104 through which apertures 106 extend. The cap 102 may be formed of synthetic resinous material or other shape-retaining material. The cap 102 defines a hollow interior 108 in which a one-way fan 52 and a flameless heater 40 are disposed immediately above, but spaced from the top surface 21 of the candle material 20 in the vessel 24.

As shown in FIG. 7, the fan and heater are connected to and suspended from the top section 110 of the cap 102 in any suitable way, the fan 52 being superimposed above and in fluid communication with the flameless heater 40. The fan 52 displaces air 112, obtained from outside the device 100, through a porous plate 114 into and thence through the heater 43, exiting through apertures in a lower porous plate 116. Thus, heated air discharge 118 impinges directly onto the top surface 21 of the candle material 20 to thereby accelerate melting and shorten the time in which fragrance is emitted. The aroma is carried by the air impinged upon surface 21 upward into the ambient environment adjacent to the fragrance release device 100 through cap apertures 106 as shown by arrows 120. The fan 52 and heater 40 of the fragrance release device 100 are turned on and off by the user by activation of switch 46, through which low voltage electricity is communicated from source 44 to the fan and the heater. When it is desired to discontinue use of the device 100, the switch 46 is placed by the user in its off condition.

Reference is now made to FIG. 8, which illustrates an additional embodiment of the present invention, generally designated 130. A flat cap 132 is caused at its downwardly directed flange 134 to be press fit over the top of the vessel 24 so as to be retained against surface 31 to prevent inadvertent separation, but also to accommodate manual removal. The flat top layer 136 is porous so as to provide a plurality of apertures 138 through which air and fragrance are allowed to pass to the surrounding environment. A flameless heater 44 is connected to the underside of the top layer 136, as is fan 146, both being suspended therefrom so as to be spaced from the top surface 21 of the candle material 20. When on, by activation of switch 46, the heater 44 emits heat 140, which impinges directly upon the top surface of the candle material 20. A reversible or two way fan 146 may be selectively actuated using reversible switch 150 and reversible motor 148 so as to either only draw fragrance-containing air out of the space 142 beneath the cap 132 and discharge it through apertures 138 disposed directly adjacent the fan, 146. In the alternative, the fan can be rotated in the opposite direction so as to displace air, as shown by arrows 144, so as to impress air at a temperature above ambient directly onto the surface 21 so as to accelerate melting and enhance the speed at which fragrance is released and carried by the discharge air 44 through one or more apertures in the cap into the environment surrounding the device 130.

To accomplish selective two way rotation of the fan 146, the reversible motor 148 is utilized to selectively drive the fan in either a clockwise or counterclockwise direction. The reverse motor 138 is controlled by three positioned reversible switch 150, which can be placed in an off position or in either of two activated positions so as to selectively rotate the fan 146 clockwise or counterclockwise, as desired. The switch 150 as well as switch 46 draws low voltage power from a source of electricity 44.

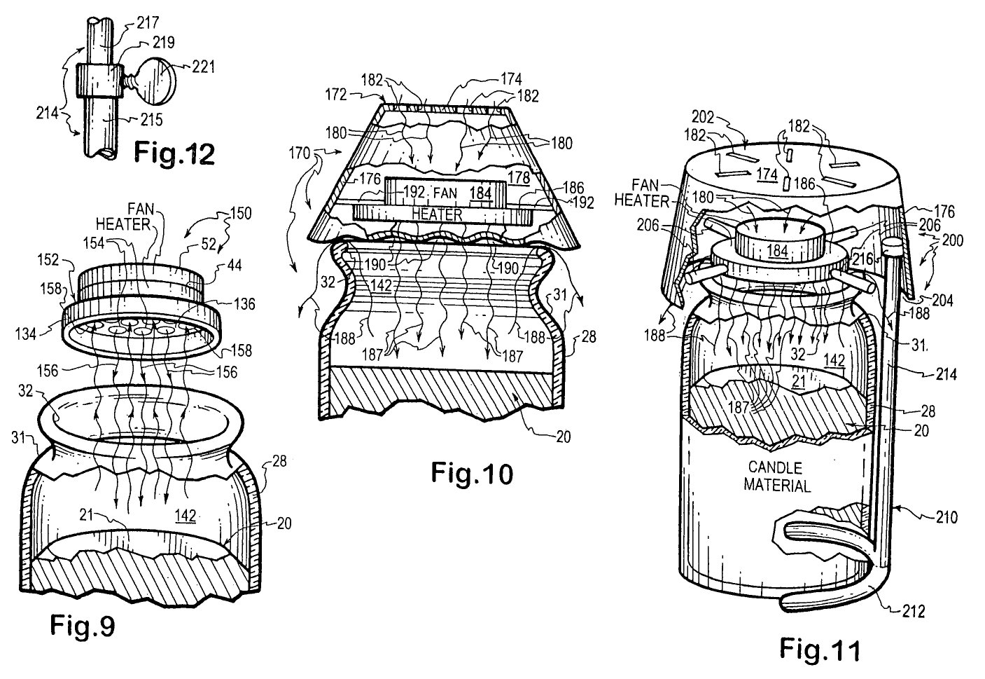

Reference is now made to FIG. 9, which illustrates an additional embodiment of the present invention, generally designated 150. The container or vessel and the candle material are essentially the same as disclosed in the above-identified embodiments, except the neck of the container is of reduced diameter. The cap 150 of device is similar to that displayed and described in connection with FIG. 8, except the fan 52 and the Blameless heater 44 are disposed on the outside of the top layer 136 of the cap 152. The fan 52, when activated, so that low voltage electricity is supplied thereto, rotates, pulling air from the surrounding environment into fan apertures 154, through the activated heater 44, exiting through apertures 154 in the cap layer 136 into the space 142 above the top surface 21 of the candle material 20, as depicted by arrows 156. The forced air, while in space 142, accelerates melting of the material 20 and picks up fragrance emitted from material 20 and carries the fragrance-bearing air upward out of the container 28 to the exterior environment through lid apertures 158. When it is no longer desired to displace aromatic air from the device 150 into the surrounding environment, the fan 52 and heater 44 are deactivated, in the manner explained above.

Reference is now made to FIG. 10 which illustrates a further embodiment of the present invention, generally designated 170. FIG. 10 illustrates a container with candle material therein similar or identical to the container depicted in FIG. 9. The cap, generally designated 172 is configurated comprises a frustro conical hood, having a top flat layer 174 and a tapered skirt layer 176. Intake air, depicted by arrows 180, passes through apertures 182 in the top layer 174 of the cap 172 pursuant to activation of the one-way fan 182. The influent air drawn into the interior 178 of the cap 172 through apertures 184 is displaced through the fan 184 and across the heater 186 to elevate the temperature of the air, which is discharged from heater 186 into the container's base 142 so as to impinge on the top surface 21 of the candle material 20. This accelerates the melting of the top of the material 20 and to infiltrate fragrance from the material 20 into the effluent air 188, which passes out of the device 170 through gaps 190 between the lower edge of the cap 172 and the upper edge of the container 28 through gaps 190. The cap 172 rests by force of gravity upon the top edge of the container 28 so that the gaps 190 are disposed above the top edge of the container 28.

The fan 184 and the heater 186 are suspended in the illustrated position by an annular impervious ring 192, which bridges between the fan and heater and the conically shaped sidewall 176 of the hood 172. As pointed out above, low voltage electricity and a manual switch deliver power to fan 184 and 186 when release of fragrance is desired, in the manner explained above.

Reference is now made to FIG. 11, which illustrates an additional embodiment of the present invention, generally designated 200. The container and candle material are the same as described above in connection with FIGS. 9 and 10 and, therefore, no further description is needed. The hood, generally designated 202, of the embodiment 200 is similar in certain respects to the cap 172 described above in connection with FIG. 10. To the extent hood 202 is the same, these parts have been correspondingly enumerated and no further description of those parts is deemed to be necessary.

The hood or cap 202, which is frustro conical in its configuration, comprises a skirt defined by tapered wall 176. The lower end of the skirt 176 is annular, not undulating, to provide a space 204 between the upper edge of the container 28 and the lower edge of the cap 202 to accommodate discharge of aroma-carrying air to the surrounding environment. The fan 184, and the heater 186 are collectively supported on spokes 206, which, when device 200 is fully assembled, rest upon the top edge of the container 28. The fan 184 and the heater 186 operate in the manner described above, in conjunction with FIG. 10. A one-piece stabilizer 210 surrounds, at arcuate portion 212, part of the bottom of the container 28 and engages, at vertical rod 214, a receptacle 215 carried at the inside of the skirt 176 to hold the cap 202 and the container 28 in stable but separate relation. The rod 214, as shown in FIG. 12, may be variable so that the stabilizer can be used with containers of different sizes. Specifically, rod 214 of FIG. 12 comprises top and bottom rod parts 217 and 215 which telescopically interrelated at collar 219. Set screw 219 can be loosened or tightened to adjust rod part 217 within rod part 215 to set the overall length of the stabilizer to fit the size of the container after which the set screw is tightened to retain that position.

The invention may be embodied in other specific forms without departing from the spirit of the central characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A combination comprising:
a container
a fragrance releasing a material disposed in the container, the material comprising a top and being solid at room temperature but having a low melting point;
a flameless heater and an air displacing fan superimposed over the material in the container, the heater and the fan accelerating the rate at which the material is melted at the top thereof to more rapidly release fragrance, the air being displaced into the room.

2. A combination according to claim 1 wherein the flameless heater is selected from the group consisting of heaters contiguous with the material and heaters above and spaced from the material.

3. A combination according to claim 2 wherein the heater is selected from the group consisting of heaters which rest at least in part contiguously on the top surface of the material and heaters which are at least in part embedded into the material from the top.

4. A combination according to claim 1 wherein the heater at least in part is carried by a container lid.

5. A combination according to claim 4 wherein a lid is superimposed over the top of the container which is pervious to discharge of fragrance bearing air from the container through the lid.

6. A combination according to claim 5 wherein the fan is carried by a container lid.

7. A combination according to claim 1 wherein the heater is disposed inside a container lid.

8. A combination according to claim 1 wherein the heater is disposed outside a container lid.

9. A combination according to claim 1 wherein the fan is disposed inside a container lid.

10. A combination according to claim 1 wherein the fan is disposed outside a container lid.

11. A combination wherein the fan displaces air across the heater and impinges hot air onto the top of the material.

12. A fragrance releasing combination comprising;
a vessel;
a quantity of fragrance-bearing material, comprising a top, disposed in the vessel, the state of which is transformed from solid to liquid upon the application of flameless heat to the top of the material;
a heating element and a fan positioned above the material by which flameless heat and fan displaced air melts the material from the top town to more rapidly emit fragrance.

13. A fragrance emitting assembly comprising;
a candle comprised of wax-like fragrance-containing material which is in a solid state at room temperature;
an impervious encasement containing the material;
a heating element and an air displacement fan disposed above the material of which the candle is comprised;
whereby application of heat by the element and displaced air from the fan onto a top of the candle within the encasement accelerates melting at the top, without communicating heat through the encasement, causing more rapid release of fragrance from the material.

14. A fragrance emitting assembly according to claim 13 wherein the heating element and the fan are associated with a cover over the encasement and further comprising a stabilizer contiguous with both the cover and the encasement in aligned vertical to prevent inadvertent separation of the cover and the encasement.

15. A fragrance emitting assembly according to claim 14 wherein the stabilizer comprises structure by which the length of the stabilizer may be varied.

16. A method of releasing a fragrance from a normally solid fragrance bearing material disposed in a receptacle, comprising the acts of:
disposing a source of heat at least in part above the material within the receptacle;
applying heat from the source direct and displaced air on a top region of the material for prompt emission of fragrance.

17. A method of emitting a fragrance comprising the acts of:
transforming a top of a solid fragrance-containing material in a container to a liquid at the top by application of heat to and air displacement onto the top causing more rapid release of the fragrance from the top of the material.

18. A method of melting candle material without combustion, comprising the acts:
combining a heater, a fan, candle with or without a wick, and a container in which the candle material is disposed;
directly and flamelessly heating the candle material at a top thereof using the heater in combination with displacement of air at above ambient temperature onto the top to promptly melt the candle material at and release fragrance from the top;
releasing air bearing fragrance to the adjacent ambient environment.
